(19) United States
(12) Patent Application Publication
(10) Pub. No.: US 2018/0362341 A1
(43) Pub. Date: Dec. 20, 2018

(54) Method to Control Hydrogen Generation by Metal Borohydride Tablets at Neutral to Near-Neutral pH

(71) Applicant: The United States of America as represented by the Secretary of the Navy, San Diego, CA (US)

(72) Inventors: Lewis Hsu, San Diego, CA (US); Michael Putnam, San Diego, CA (US); Greg Anderson, San Diego, CA (US)

(21) Appl. No.: 15/626,604

(22) Filed: Jun. 19, 2017

(51) Int. Cl. C01B 3/06; C01B 35/00

(52) U.S. Cl. CPC C01B 3/065; C01B 35/00

(57) ABSTRACT

A method for generating hydrogen, wherein a tablet is formed using a solid acid, a metal borohydride, and an inert binder, and that tablet is placed into a volume of water, causing hydrogen to be released.

### FEDERALLY-SPONSORED RESEARCH AND DEVELOPMENT

Method for Controlling Hydrogen Generation by Metal Borohydride Tablets at Neutral to Near-Neutral pH is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email ssc_pac_T2@navy.mil. Reference Navy Case Number 106090.

### BACKGROUND

The reaction of metal borohydrides with water is a well-known technique to release hydrogen gas (H₂) under controlled conditions. This reaction allows the borohydride salts to be used as hydrogen storage. However, there are several issues with the release of hydrogen during the reaction of the salts with water. In the absence of a catalyst or other additive, the borohydride-water reaction consumes protons and creates a high pH condition. This will lead to the formation of undesirable products and inhibits the borohydride-water reaction.

The challenge of storing H₂, which has notoriously low energy density when uncompressed or in liquid form has been solved by implementing a solid chemical storage technique. This involves storing the borohydride salt, such as sodium borohydride (NaBH₄) in a dense pellet form that is also pre-doped with a cobalt chloride (CoCl₂) catalyst. NaBH₄ releases a large amount of H₂ (four moles to every mole of NaBH₄) when mixed with water through a hydrolysis reaction. In the developed system, water and NaBH₄ are stored separately rather than gaseous H₂. While the stored energy density of NaBH₄ is lower than that of highly pressurized H₂, it allows for safer transportation, no leakage issues, and easier replacement for extended mission lifetime.

Results have shown that the reaction utilizing catalyst-doped pellets does not consume the entire amount of catalyst, causing such problems as leaving remaining catalyst in the solution for future reactions which then become more vigorous, evolving gas faster and increasing the temperature, catalyst degradation and waste-build-up. Additionally, catalysts most commonly used are based on transition metals (Co, Ru, Ni) and are hazardous materials, often carcinogenic, and require special handling. The pH of the solutions is also quite high, requiring additional special handling.

Another method used is the use of accelerators, either an inorganic salt like B₂O₃ or acids. Implementation of these techniques has generally relied on adding the accelerator to a water source and controlling the reaction by limiting the introduction of the water-accelerator mixture to the NaBH₄. This has been documented to require acid handling (since the acid is a hazardous material) and can still result in an undesired side reaction. In addition, most methods require a solution of the NaBH₄ and/or the accelerator, which lowers the possible energy density and eliminates one of the more favorable reasons for choosing borohydride for hydrogen storage.

Described herein is a method to mitigate the problems stated above in generating hydrogen that allows for safe handling and disposal of compounds in the field. Additionally, this method helps to minimize any excess solution volume or chemical handling to maintain ease of use and simplify integration into complete systems.

### BRIEF DESCRIPTION OF THE DRAWINGS

FIG. 1 shows a spreadsheet tool for calculating the amount of solid acid to add to the borohydride salt to form a tablet used in hydrolysis in accordance with the Method for Controlling Hydrogen Generation by Metal Borohydride Tablets at Neutral to Near-Neutral pH.

FIGS. 2A-2C show a demonstration of dropping a tablet having a chemical mixture of a metal borohydride, a non-hazardous solid acid, and an inert binder, into water allowing for hydrolysis to take place in accordance with the Method for Controlling Hydrogen Generation by Metal Borohydride Tablets at Neutral to Near-Neutral pH.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment,” “in some embodiments,” and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

Described herein is a method for hydrogen generation using a relatively stable mixture of a metal borohydride (such as sodium borohydride) and a non-hazardous solid acid. The use of mineral acids (hydrochloric acid and sulfuric acid) and organic acids (citric acid and acetic acid) are suitable for hydrogen generation. The method described herein is an alternative approach to generating hydrogen using green chemistry. Instead of utilizing potentially toxic and environmentally harmful catalysts to promote borohydride hydrolysis, this method demonstrates that hydrogen release can be performed successfully with several different acid accelerators. With the addition of an inert binder such as cellulose, hydrogen can be reliably generated with the simple addition of water, and neutral pH values are maintained even after the reaction is complete.

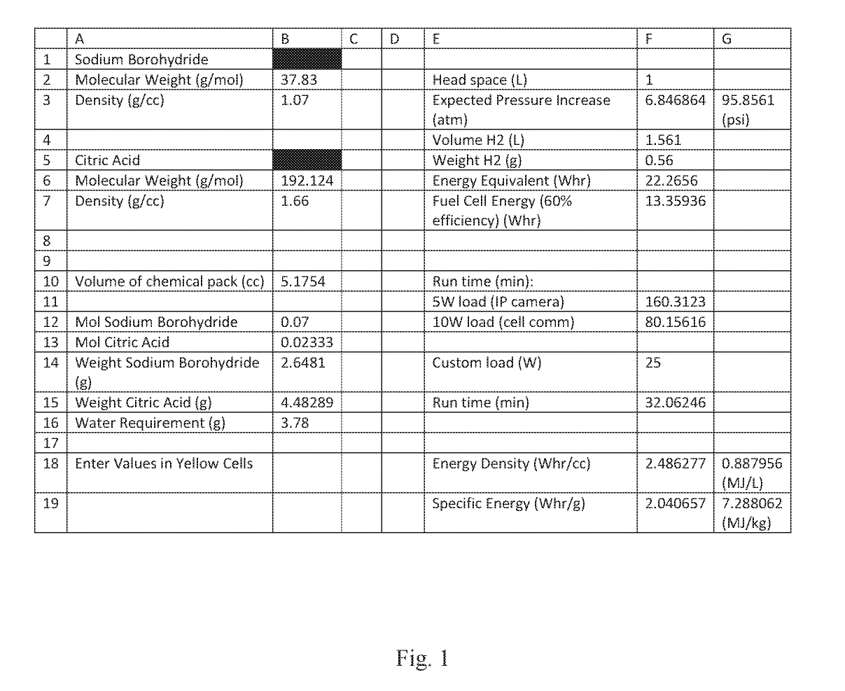

FIG. 1 shows a spreadsheet tool for calculating the amount of solid acid to add the NaBH₄ to reach hydrolysis. To estimate the rates of hydrolysis with each acid, peak gas generation rate at the beginning of each reaction was used to calculate pseudo-first order rate constants. Several reports have proposed the following reaction for acid accelerated borohydride hydrolysis.

BH4⁻+H⁺+3H₂O→B(OH)₃+4H₂ [1]

From this reaction, the rate of hydrogen gas production can be described in the following equation:

Rate of H₂ production=k[BH4⁻]^{x}[H⁺]^{y}[H2O]^{z} [2]

where k is a rate constant associated with Equation 1, x is the reaction order with respect to borohydride, y is the reaction order with respect to proton concentration, and z is the reaction order with respect to the water concentration.

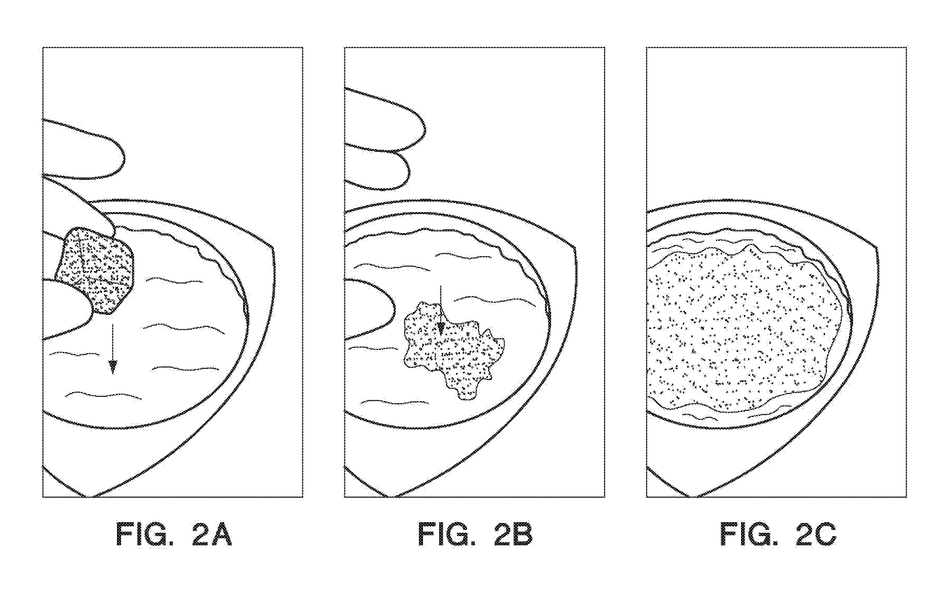

FIG. 2A shows a metal borohydride, inert binder, and solid acid formed into a tablet. FIG. 2B shows the tablet being dropped into a container of water. FIG. 2C shows the generation and release of hydrogen when the pellet and water interact. Here, neutral pH is maintained even after reaction completion.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method comprising:
mixing a metal borohydride with an inert binder and a solid acid, forming a solid tablet;
adding water to the tablet causing hydrogen gas to be released.

2. The method of claim 1, further comprising capturing the hydrogen.

3. The method of claim 2 wherein the metal borohydride is sodium borohydride.

4. The method of claim 2 wherein the inert binder is cellulose.

5. The method of claim 2 wherein the solid acid is citric acid.

6. The method of claim 2 wherein the solid acid is phosphoric acid.

7. A method for generating hydrogen comprising:
forming a solid acidic tablet using a metal borohydride, an inert binder, and a solid acid;
placing the tablet into a volume of water, causing hydrogen to be released.

8. The method of claim 7, further comprising capturing the released hydrogen.

9. The method of claim 8 wherein the metal borohydride is sodium borohydride.

10. The method of claim 9 wherein the solid acid is citric acid.

11. The method of claim 10 wherein the inert binder is cellulose.

12. The method of claim 11 wherein 0.07 mol of sodium borohydride having a weight of 2.6481 grams and 0.02333 mol of citric acid having a weight of 4.48289 grams are added to the cellulose to form the solid acidic tablet.

13. A method for generating hydrogen comprising:
combining a metal borohydride, an inert binder, and a solid acid;
adding that combination to a volume of water.

14. The method of claim 13 wherein combining the metal borohydride, inert binder, and the solid acid forms a tablet.

15. The method of claim 13 wherein combining the metal borohydride, inert binder, and the solid acid forms a powder.
